(19) United States
(12) Patent Application Publication
(10) Pub. No.: US 2024/0166288 A1
(43) Pub. Date: May 23, 2024

(54) BICYCLE BELL HAVING A MOUNTABLE POSITIONER

(71) Applicant: Shen zhen shi zhong chuang xun da ke ji you xian gong si, Shenzhen (CN)

(72) Inventor: Yuanhui Zhang, Huizhou (CN)

(21) Appl. No.: 18/056,360

(22) Filed: Nov. 17, 2022

(51) Int. Cl. B62J 3/04

(52) U.S. Cl. CPC B62J 3/04

(57) ABSTRACT

The invention discloses a bicycle bell having a mountable positioner, comprising a fixing element (3) for fixing the handle of the bicycle, a sound element (1) for generating a bell, and a sound trigger for striking the sound element (2); characterized in that, when the sound element (1) and the sound trigger (2) are combined, an accommodation chamber (107) is formed between the sound element (1) and the sound trigger (2), and the accommodation chamber The positioning device (4) of different sizes can be installed, and a waterproof rubber ring (204) is built in the accommodating chamber.

### TECHNICAL FIELD

The invention relates to the field of bicycle parts, in particular to a bicycle bell having a mountable positioner.

### BACKGROUND

The car bell is an indispensable part on the bicycle, and the existing car bell only has the function of sounding as a warning bell when encountering pedestrians or vehicles blocking, so as to avoid collision with pedestrians or vehicles. With the development of science and technology, locator devices are also used in various fields. The known system components for locating bicycles are all installed in positions that are easy to find. The structure of the bicycle surface is simple and there is not much hidden space. But the bike was stolen and the thief removed the locator system on the surface, which means the result of the bike being stolen can't be found.

### SUMMARY

The purpose of the present invention is to provide a bicycle bell having a mountable positioner. The cavity built into the bell of the present invention can satisfy the installation of locator devices of different sizes, so as to achieve a hidden locating effect and easily help users Find the lost vehicle.

In order to achieve the above purpose, the present invention provides a bicycle bell having a mountable positioner, comprising a fixing element (3) for fixing the handle of the bicycle, a sound element (1) for generating a bell, and a sound element (1) for percussion sound, Sound trigger (2) of the element, chamber (107) containing the protective locator device. A fixing screw is arranged at the opening of the fixing element on the handle of the fixed bicycle; a fixing protrusion is arranged above the fixing element on the handle of the fixed bicycle with a built-in thread; The frame is provided with a groove corresponding to the size of the fixed protrusion; the beater extension frame is provided with an elastic frame, and a beating head is provided on the side of the top of the elastic frame; a waterproof rubber ring is built in the cavity for accommodating the protection locator device.

Preferably, when the sound element and the sound trigger are combined, a accommodating chamber is formed between the sound element and the sound trigger, and the accommodating chamber can accommodate positioning devices of different sizes.

Preferably, a track protrusion and a track groove are arranged above the sound trigger fixing member, holes with a uniform distance are arranged beside the track groove, and fixing screws are provided to fix the sound element and the sound trigger assembly.

Preferably, the waterproof rubber ring built into the chamber presses and locks the inside of the track protrusion of the sound trigger fixing member, so as to achieve the waterproof function.

Therefore, the present invention adopts the above-mentioned structure of a bicycle bell having a mountable positioner, and the accommodating chamber formed by the combination of the sound element and the sound trigger can better hide and protect the locator device.

a bicycle bell having a mountable positioner of the present invention is further described below through the accompanying drawings and embodiments.

### DESCRIPTION OF DRAWINGS

In order to illustrate the embodiments of the present invention or the technical solutions in the prior art more clearly, the following briefly introduces the accompanying drawings that are used in the description of the embodiments or the prior art. Obviously, the drawings in the following description are only These are some embodiments of the present invention. For those skilled in the art, other drawings can also be obtained according to these drawings without creative effort.

FIG. 1 is the use state of the present invention;

FIG. 2 is the disassembled state of the present invention;

FIG. 3 is a state in which the accommodating chamber of the present invention is opened;

FIG. 4 is a cross-section of the state in which the accommodating chamber is opened according to the present invention.

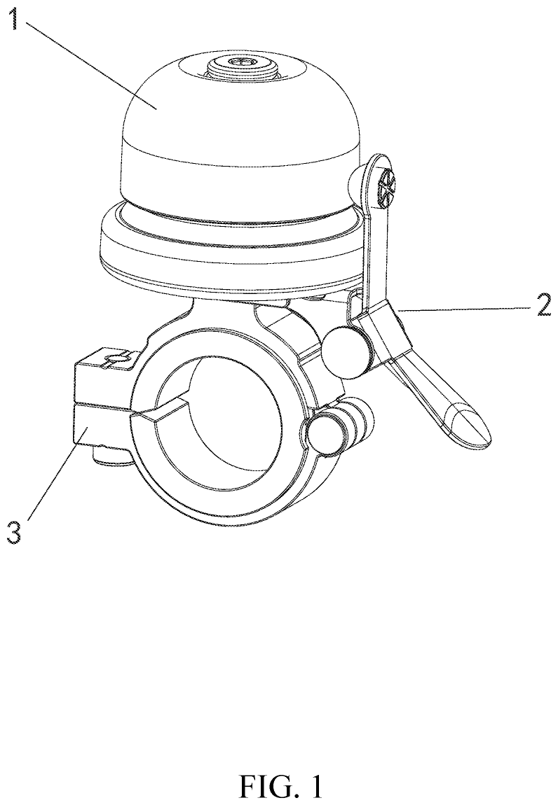

See FIG. 1, showing the sound element (1), sound trigger (2), handlebar fixing element (3), which is the basic structure of the appearance of the present invention in use.

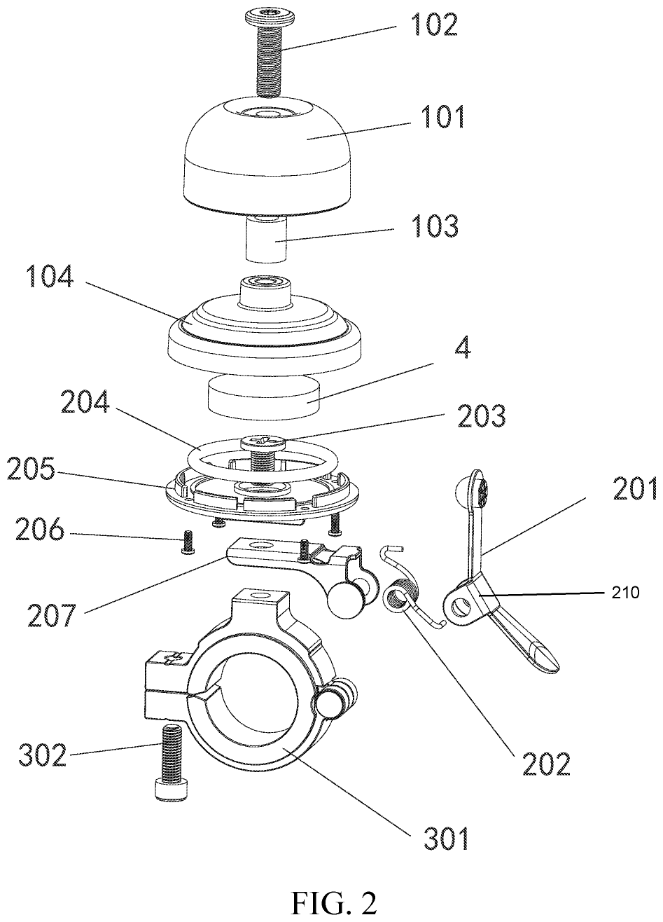

See FIG. 2, showing the sound element knock shell (101), set screw (102), sound element knock shell height adjustment (103), chamber housing (104), locator device (4), strike device (201), beater U-shaped interface (210), elastic frame (202), fixing screw (203), waterproof rubber ring (204), sound trigger fixing piece (205), fixing screw (206), The beater extension frame (207), the handlebar fixing element ring (301), and the handlebar fixing screw (302) are the disassembled state structure of the present invention.

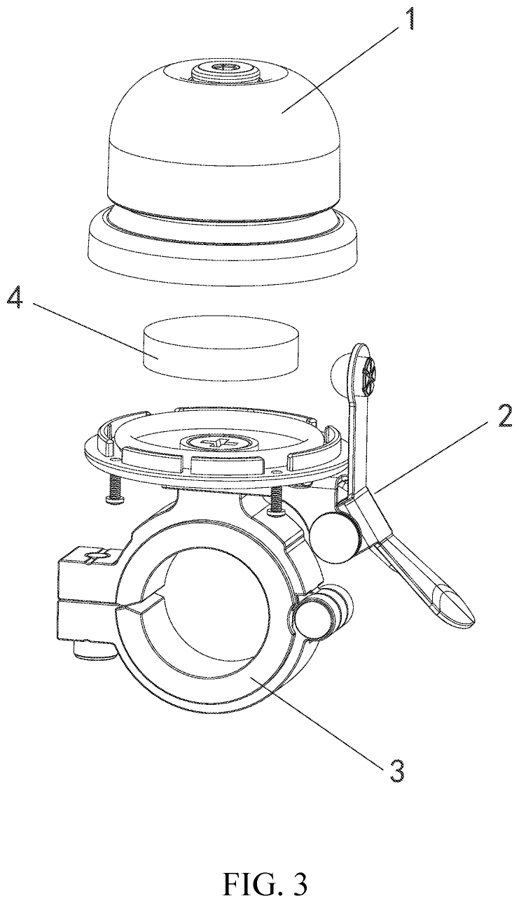

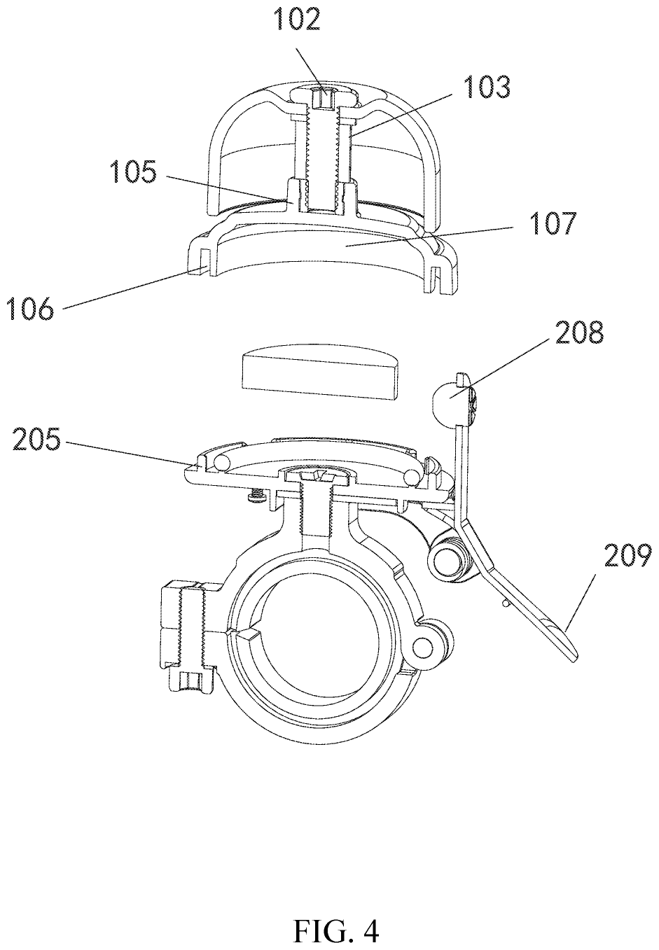

See FIG. 3, FIG. 4, FIG. 3 is the state schematic diagram after the present invention opens the sound element, FIG. 4 is the cross-sectional view after the present invention opens the sound element state, FIG. 4 shows the sound element percussion shell height adjustment member (103), circular protrusion (105), chamber housing track groove (106), chamber (107), beating head (208), sound trigger pressing plate (209), fastener disc (205).

### DETAILED DESCRIPTION

The present utility model will be further described below through specific embodiments and accompanying drawings.

As shown in FIG. 1 and FIG. 2, a bicycle bell having a mountable positioner includes a sound element (1), a sound trigger (2), and a handlebar fixing element (3), wherein the fixing screw (102) is used for It is used to fix the connection between the sound element striking shell (101) and the chamber shell (104); the fixing screw (203) is used to fix the sound trigger fixing part (205) and the expansion frame (207) on the handlebar fixing element (3) Upper; 4 setscrews (206) for the reinforced connection of the sound trigger fixing (205) and the chamber housing (104); setscrews (302) for fixing the handlebar fixing element ring (301) on the handlebars of the bicycle.

Specifically, in the bicycle bell capable of installing a locator device, the sound element (1) and the sound trigger (2) are combined to form an accommodating chamber, and the space of the chamber can meet the installation of locator devices of different sizes, thereby Better hidden locator device.

Specifically, in order to better protect the bicycle bell of the locator device, a waterproof rubber ring (204) is provided in the sound trigger fixing member (205).

Specifically, in the bicycle bell capable of installing a locator device, five track grooves (106) are provided on the bottom edge of the chamber shell (104), and four evenly spaced grooves are provided on the plane position beside the track groove Threaded holes; 5 track protrusions are arranged above the sound trigger fixing member, and 4 holes are provided with even distances at the groove position next to the track protrusions; the 5 track protrusions above the sound trigger fixing member (205) and The positions of the 5 track grooves at the bottom of the chamber shell (104) correspond to the positions of the 5 track grooves of the sound trigger fixing piece, and the 4 holes at the position of the track grooves of the sound trigger fixing piece correspond to the 4 threaded holes at the bottom of the chamber shell; the chamber shell is fixed with the sound trigger The parts are assembled by the combination of the upper and lower grooves, and are fixed with screws.

Specifically, in the bicycle bell on which the locator device can be installed, when the battery of the locator device (4) is insufficient, the chamber can be opened by removing the four fastening screws (206), so as to take out the locator device, and then Replace batteries or recharge the positioner unit.

Specifically, in the bicycle bell on which a locator device can be installed, the sound element knocking shell height adjusting member (103) is connected to the circular protrusion (105), and the sound element knocking shell height adjusting member (103) can be stretched To adjust the length, the circular protrusion (105) has a built-in threaded hole; the sound element percussion shell height adjustment member (103) is fixed by the fixing screw (102), the sound element percussion shell (101) and the circular protrusion (105). The series is fixed in the middle position.

Specifically, in the bicycle bell that can be installed with a locator device, the elastic frame (202) is formed by bending elastic metal wires, has a Z-shaped structure, and is divided into an upper fixed section, a lower fixed section and a middle connecting section. The fixed section at the upper end of the frame (202) is connected with the square groove of the beater extension frame (207). 207) embedded in the lower side of the series assembly.

Specifically, in the bicycle bell on which the locator device can be installed, the handlebar fixing element ring (301) is provided with an opening and a rotating final shaft. When the bicycle bell needs to be fixed on the bicycle handlebar, the handlebar fixing element can be easily opened. Ring (301) and lock with Set Screw (302).

Specifically, in the bicycle bell on which a locator device can be installed, when a pedestrian or a vehicle is blocked, the sound trigger pressing plate (209) is pressed, and the beating head (208) hits the sound element (1), thereby Sounds an echo tone to alert pedestrians or vehicles.

What is claimed is:

1. A bicycle bell having a mountable positioner, comprising
a fixing element (3) configured to secure a bicycle handlebar,
a sound element (1) configured to generating a bell,
a sound trigger (2) configured to knock the sound element, and
a chamber (107) configured to accommodate and protect the positioner;
wherein
the fixing element configured to secure a bicycle handlebar is provided with a fixing screw at an opening thereon;
the element configured to secure a bicycle handlebar is provided with a fixed bulge with built-in threads; and
the fixed bulge is connected to an expand shelf of a knocker, and the expand shelf is provided with a recess corresponding in size to the fixed bulge;
the expand shelf of the knocker is provided with an elastic shelf, and the elastic shelf is provided with a beating head at a top side thereon; and
the chamber configured to accommodate and protect the positioner is configured with a waterproof rubber ring (204) inside.

2. The bicycle bell according to claim 1, wherein when the sound element (1) and the sound trigger (2) are combined, the sound element and the sound trigger is formed the chamber (107).

3. The bicycle bell according to claim 1, wherein the waterproof rubber ring (204) is configured to press and stuck inside a track bulge above a sound trigger retainer (205).

4. The bicycle bell according to claim 3, wherein a chamber housing (104) is provided with 5 track recesses (106) at a bottom thereon, and 4 threaded holes at an even distance are provided in a flat position next to the track recesses.

5. The bicycle bell according to claim 4, wherein the sound trigger retainer (205) is provided with 5 track bulges above, and 4 holes at an even distance are provided in the track recesses next to the track bulge.

6. The bicycle bell according to claim 5 wherein 5 track bulges above the sound trigger retainer (205) correspond to 5 track recesses (106) at the bottom of the chamber housing (104), 4 holes in the track recesses of the sound trigger retainer (205) correspond to 4 threaded holes at the bottom of the chamber housing (104), and the chamber housing (104) is assembled with the sound trigger retainer (205) by combining upper and lower recesses, and 4 fixing screws are provided.

7. The bicycle bell according to claim 1, a positioner configured to determine a position of a bicycle is disposed in the chamber (107), in particular, the chamber is configured to provide a mounting position of the positioner (4) configured to determine the position of the bicycle, and the mounting position is configured to place a passive or active NFC transmitter, a GNSS transmitter, and a Bluetooth transmitter; and a space in the chamber allows for a placement of different sized positioner.
